(19) United States
(12) Patent Application Publication
(10) Pub. No.: US 2007/0284877 A1
(43) Pub. Date: Dec. 13, 2007

(54) Connecting mechanism for composite pipes and plastic pipes as well as a corresponding arrangement

(75) Inventor: Gerhard Glinzerer, Hinterbruhl (AT)

Correspondence Address: MICHAUD-DUFFY GROUP LLP, 306 INDUSTRIAL PARK ROAD, SUITE 206, MIDDLETOWN, CT, 06457, US

(73) Assignee: IPA Produktions- & Vertriebsges.m.b.H., Wien (AT)

(21) Appl. No.: 11/804,361

(22) Filed: May 18, 2007

(30) Foreign Application Priority Data
May 19, 2006 (DE) 202006008069.4

(51) Int. Cl. F16L 31/00

(52) U.S. Cl. 285/222.5

(57) ABSTRACT

The invention relates to a connecting mechanism for composite and plastic pipes with a metal layer and at least one plastic layer, a connecting portion, a supporting sleeve which adjoins the connecting portion in the direction opposite the fitting direction and a clamping ring with a radial, plastically deformable extension, the plastic deformation of which reduces its circumference.

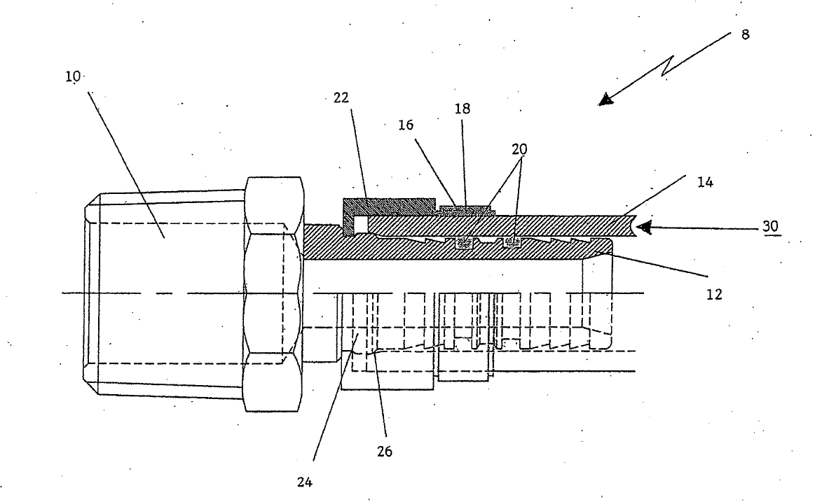

### CROSS-REFERENCE TO RELATED APPLICATIONS

This application claims priority to German Utility Model No. 20 2006 008 069.4 filed on May 19, 2006, the subject matter of this patent is incorporated by reference herein in its entirety.

### FIELD OF THE INVENTION

The invention relates to a connecting mechanism for composite pipes and to an arrangement incorporating a composite pipe.

### BACKGROUND OF THE INVENTION

A large number of different connecting mechanisms are used for heating and plumbing systems on building sites, which are more or less complex in terms of design. Commonly used connecting mechanisms are provided with a plastically deformable press-fit sleeve to enable plastic pipes and in particular composite pipes with at least one metal layer and at least one plastic layer, which as a rule lies on the inside, to be secured to a connecting mechanism. With this system, a cylindrical press-fit sleeve is pushed over a supporting sleeve of a connecting mechanism and a pipe can be pushed into the annular space between the supporting sleeve and press-fit sleeve. Due to a permanent plastic compression which thus partially reduces the diameter of the press-fit sleeve, the pipe can be secured in the connection.

A connecting mechanism of this type and an arrangement incorporating a pipe known from the prior art is relatively complex and expensive. A special pressing tool is also needed, the weight of which is between 10 and 15 kg. The pressing operation using such a pressing tool is relatively awkward and can not simply be carried out at all points of the building site.

### SUMMARY OF THE INVENTION

Accordingly, the objective of this invention is to design a connecting mechanism and a corresponding arrangement which is less expensive and can preferably be connected to a plastic pipe or composite pipe with a simple tool, in particular simple pliers.

The advantages which can be achieved as a result of the invention are based on a connecting mechanism for composite pipes with a metal layer and at least one plastic layer, and the connecting mechanism is provided with a connecting portion in order to secure or connect the connecting mechanism. A supporting sleeve is also provided, which extends the connecting portion and can be pushed onto the plastic pipe or composite pipe. In order to secure the plastic pipe or composite pipe on the supporting sleeve, a clamping ring with a radial, plastically deformable extension in the circumferential direction is provided, the plastic deformation of which reduces the circumference of the clamping ring in order to secure a pipe end of the composite pipe or pipe on the supporting sleeve and optionally press against a sealing device, if one is provided, due to the reduction in the circumference of the clamping ring.

In a preferred embodiment, at least one sealing device, and preferably several, in particular two sealing devices, are provided on the supporting sleeve, to at least one of which a pressing force is applied due to the reduction in the diameter of the clamping ring induced by the operation of securing the connecting mechanism and composite pipe.

In another preferred embodiment, a positioning ring may be provided, which sits on the supporting sleeve and which positions the composite pipe on the supporting sleeve. The positioning ring can also be positioned so that the clamping ring lies against the positioning ring at its end face, thereby providing a defined position for the clamping ring on the pipe end. This pre-defined position of the clamping ring may preferably be used to press or apply pressure to at least one of the sealing devices provided.

It is of particular advantage to provide an outer ring, which sits on the composite pipe that is to be pushed on the supporting sleeve, and this outer ring is provided with an overlap region in the circumferential direction. The clamping ring may lie on the outer ring and radially compress it, thereby resulting in a gentle pressing action on the composite pipe lying underneath as well as on the seal lying under the latter. This being the case, the outer ring may also be provided with at least one circumferential guide, which is provided as a means of retaining the clamping ring in its pre-defined position on the outer ring and guiding it during the pressing operation.

The positioning ring is preferably a plastic ring, which extends in the direction opposite that in which the composite pipe is pushed on, in order to surround the end of the composite pipe or plastic pipe.

The positioning ring may also be provided with a portion with a preferably reduced wall thickness or external diameter, onto which the clamping ring or the outer ring is pushed and can therefore be pre-fitted. In this way, the clamping ring or the arrangement comprising the clamping ring and outer ring can be retained on the connecting mechanism proposed by the invention pre-assembled. The pipe to be fitted can simply be pushed in here, requiring no other measures.

In one embodiment, the supporting sleeve has at least a partially circumferential structure, into which the positioning ring can be latched or onto which it can be snap-fitted. As a result, the positioning ring can be retained in a pre-defined position in order to reduce fitting errors during fitting.

The supporting sleeve of the connecting mechanism proposed by the invention preferably has a stop portion close to its terminal end, against which an inner plastic layer of the composite pipe abuts in order to terminate the pushing-on operation. This avoids any galvanic contact between the connecting mechanism made from a metal, in particular the supporting sleeve, and the metal layer of the composite pipe, thereby offering a simple way of obtaining a galvanic separation.

An arrangement incorporating a composite pipe with at least one metal layer and at least one plastic layer as well as a connecting mechanism based on the invention as explained above can likewise offer all the advantages described above and may incorporate all said features.

As explained above, the invention may be used in conjunction with both plasitic and composite pipes.

### DESCRIPTION OF THE DRAWING

The invention will be explained in more detail below on the basis of a preferred embodiment illustrated in the single, appended drawing, which shows partially a longitudinal cut and partially a side view. Other characteristics, features and objectives of the invention will become apparent.

### DESCRIPTION OF THE PREFERRED EMBODIMENT

The drawing illustrates an arrangement 8 as proposed by the invention, comprising a connecting portion 10, a supporting sleeve 12 adjoining it and a clamping ring 16.

A plastic pipe or composite pipe 14 is pushed onto the supporting sleeve 12 in the fitting direction 30 (indicated by the directional arrow), and the clamping ring 16 pre-positioned on the pipe end of the pipe 14, for example, preferably moves so that it lies above a sealing device 20, for example an 0-ring made from a rubber material or similar.

The part of the description of the drawing given above relates to the basic features of the connecting mechanism proposed by the invention and the arrangement proposed by the invention.

The embodiment illustrated comprises a supporting sleeve 12, which is provided with two sealing devices or 0-rings 20 in respective circumferential grooves.

A positioning ring 22 preferably made from plastic is snap-fitted onto the supporting sleeve 12, and the radially tapered end of the positioning ring 22 is snap-fitted into a co-operating notch or groove 24 of the supporting sleeve. The supporting sleeve has a stop 26, against which a terminal end of the composite pipe 30 abuts so that the inner plastic layer of the composite pipe 14 runs against the stop 26, thereby enabling a galvanic contact between a metal layer (not illustrated) of the composite pipe and the connecting mechanism to be prevented.

The clamping ring 16 sits above an outer ring on the surface of the composite pipe 14. The clamping ring 16 has a radial, plastically deformable extension in the circumferential direction, the plastic deformation of which reduces its circumference. When this extension is compressed and the circumference of the clamping ring reduced, the outer ring is simultaneously compressed so that ends of the outer ring lying one above the other in the circumferential direction and displaceable in the circumferential direction can be moved in opposite directions so that the circumference of the outer ring is reduced as the circumference of the clamping ring is reduced, thereby securing the pipe end on the supporting sleeve 12.

In the direction opposite the fitting direction 30, the positioning ring 22, preferably made from plastic, may have a cylindrical extension on which the clamping ring 16 and, if one is provided, the outer ring 18, can be pre-positioned, thereby avoiding a separate positioning and obviating the need to store and transport the clamping ring 16 and the outer ring 18 as separate parts.

The supporting sleeve 12 may be provided with circumferential teeth, spikes and similar in a standard manner in order to retain the fitted and secured composite pipe firmly on the connecting mechanism proposed by the invention and thus additionally secure the arrangement proposed by the invention.

A top part of the drawing shows a diagram in section, whilst the other part of the drawing is a side view illustrating the contours.

As a rule, a connecting mechanism as proposed by the invention will be of a generally cylindrical shape, in which case all the constituent elements likewise have a cylindrical symmetry. In this situation, only the radial, plastically deformable extension (not illustrated) of the clamping ring essentially deviates from the cylindrical symmetry of the other parts of the connecting mechanism proposed by the invention. As mentioned above, the advantage of the connecting mechanism proposed by the invention is that it can be fitted without the need for a special pressing tool and without special pressing jaws.

Known systems require a plurality of different pressing jaws for every pressing tool because a connecting mechanism needs a special pressing jaw contour with a correspondingly sized diameter to connect a pipe of virtually each different diameter in a known manner. Furthermore, the invention results in a fitting which can not be released without destroying the finished connecting mechanism. The compressed region of the connecting mechanism proposed by the invention is clearly identifiable due to the deformation of the radial, plastically deformable extension. It is also possible to tell that a connecting mechanism proposed by the invention has not yet been compressed by the shape of the isolating ring. Tolerances in the constituent parts of the connecting mechanism can be easily overcome because any annular gaps between the supporting sleeve and the fitted composite pipe or the composite pipe and the clamping ring 16 can be tolerated due to a generous dimensioning of the clamping ring 16 and if necessary the ring 18. Finally, a leakage function can also be provided by means of a supporting sleeve with a reduced diameter, which also makes it obvious if connections proposed by the invention have not been compressed or have not been sufficiently compressed.

1. A connecting mechanism for composite and plastic pipes with a metal layer and at least one plastic layer,
with a connecting portion,
with a supporting sleeve which adjoins the connecting portion in the direction opposite the fitting direction and
with a clamping ring with a radial, plastically deformable extension in the circumferential direction, the plastic deformation of which reduces its circumference.

2. The connecting mechanism according to claim 1, wherein at least one, preferably two or more sealing devices are provided on the supporting sleeve.

3. The connecting mechanism according to claim 1, wherein a positioning ring which sits on the supporting sleeve and which positions the composite pipe on the supporting sleeve or positions the clamping ring on the pipe.

4. The connecting mechanism according to claim 1, wherein an outer ring is provided, which sits on the composite pipe to be fitted on the supporting sleeve and which is provided with an overlap region in the circumferential direction, and the clamping ring lies on the outer ring in order to compress it radially when the clamping ring is deformed.

5. The connecting mechanism according to claim 3, wherein the positioning ring is a plastic ring, which extends in the direction opposite the fitting direction of the composite pipe and surrounds the end of the composite pipe.

6. The connecting mechanism according to claim 4, wherein the positioning ring is a plastic ring, which extends in the direction opposite the fitting direction of the composite pipe and surrounds the end of the composite pipe.

7. The connecting mechanism according to claim 3, wherein the positioning ring has a portion with a preferably reduced wall thickness or diameter, on which the clamping ring or the outer ring and the clamping ring can be pre-fitted.

8. The connecting mechanism according to claim 4, wherein the positioning ring has a portion with a preferably reduced wall thickness or diameter, on which the clamping ring or the outer ring and the clamping ring can be pre-fitted.

9. The connecting mechanism according to claim 5, wherein the positioning ring has a portion with a preferably reduced wall thickness or diameter, on which the clamping ring or the outer ring and the clamping ring can be pre-fitted.

10. The connecting mechanism according to claim 6, wherein the positioning ring has a portion with a preferably reduced wall thickness or diameter, on which the clamping ring or the outer ring and the clamping ring can be pre-fitted.

11. The connecting mechanism according to claim 3, wherein the supporting sleeve has an at least partially circumferential structure into which the positioning ring can be latched or onto which it can be snap-fitted.

12. The connecting mechanism according to claim 1, wherein the supporting sleeve has a stop portion close to its terminal end, against which an inner plastic layer of the composite pipe can be positioned in abutment in order to terminate the fitting operation.

13. An arrangement comprising a composite pipe with at least one metal layer and at least one plastic layer as well as a connecting mechanism according to claim 1.
